(19) United States
(12) Patent Application Publication
(10) Pub. No.: US 2025/0148637 A1
(43) Pub. Date: May 8, 2025

(54) POSITION DETERMINING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Panwang PAN, Beijing (CN); Jiao CHEN, Beijing (CN); Cheng CHEN, Beijing (CN); Yunlong LI, Beijing (CN); Meifeng XIAO, Beijing (CN)

(21) Appl. No.: 18/934,946

(22) Filed: Nov. 1, 2024

(30) Foreign Application Priority Data
Nov. 3, 2023 (CN) 202311459843.3

(51) Int. Cl. G06T 7/70

(52) U.S. Cl. CPC G06T 7/70; G06T 2207/20076; G06T 2207/20081

(57) ABSTRACT

The present disclosure provides a position determining method and apparatus, an electronic device and a storage medium. The method includes: determining whether a target object is located in a blind area of a camera at n historical moments of a historical time queue and a target moment; wherein the historical time queue is configured to store historical position information of the target object at latest n historical moments prior to the target moment, where n is a preset positive integer not less than 2; and in response to the target object being located outside the blind area of the camera at both of the n historical moments and the target moment, determining position information of the target object acquired by the camera at the target moment as the position information of the target object at the target moment.

### CROSS-REFERENCE TO RELATED APPLICATION(S)

This application claims the priority to Chinese patent application No. 202311459843.3 filed with the SIPO on Nov. 3, 2023 and entitled “POSITION DETERMINING METHOD AND APPARATUS, ELECTRONIC DEVICE, AND STORAGE MEDIUM”, which is incorporated herein in its entirety by reference.

### TECHNICAL FIELD

The present disclosure relates to the technical field of computers, in particular to a position determining method and apparatus, an electronic equipment and a storage medium.

### BACKGROUND

When using an extended reality device, the handle is usually used to control the extended reality device, and the position of the handle is the important information for controlling the content displayed by the extended reality device. Generally, the position of the handle is tracked by an integration based on inertial measurement unit (IMU).

### SUMMARY

Embodiments of the present disclosure provide a position determining method and apparatus, an electronic device and a storage medium.

Embodiments of the present disclosure adopt the following technical solution.

In some embodiments, the present disclosure provides a position determining method, including:
determining whether a target object is located in a blind area of a camera at n historical moments of a historical time queue and a target moment; wherein the historical time queue is configured to store historical position information of the target object at latest n historical moments prior to the target moment, where n is a preset positive integer not less than 2; and
in response to the target object being located outside the blind area of the camera at both of the n historical moments and the target moment, determining position information of the target object acquired by the camera at the target moment as the position information of the target object at the target moment.

In some embodiments, the present disclosure provides a position determining apparatus, including:
a control unit, configured to determine whether a target object is located in a blind area of a camera at n historical moments of a historical time queue and a target moment; wherein the historical time queue is configured to store historical position information of the target object at latest n historical moments prior to the target moment, where n is a preset positive integer not less than 2;
the control unit is further configured to determine position information of the target object acquired by the camera at the target moment as the position information of the target object at the target moment in response to the target object being located outside the blind area of the camera at both of the n historical moments and the target moment.

In some embodiments, the present disclosure provides an electronic device, including at least one memory and at least one processor; wherein
the at least one memory is configured to store program codes, and
the at least one processor is configured to call the program codes stored in the memory to execute the position determining method described above.

In some embodiments, the present disclosure provides a computer-readable storage medium for storing program codes, wherein the program codes, when executed by a processor, cause the processor to perform the position determining method described above.

### BRIEF DESCRIPTION OF DRAWINGS

The above and other features, advantages and aspects of embodiments of the present disclosure will become more apparent by referring to the following detailed description when taken in conjunction with the accompanying drawings. Throughout the drawings, the same or similar reference numerals indicate the same or similar elements. It should be understood that the drawings are schematic, and components and elements are not necessarily drawn to scale.

FIG. 1 is a schematic diagram of an extended reality device used in an embodiment of the present disclosure.

FIG. 2 is a flowchart of a position determining method according to an embodiment of the present disclosure.

FIGS. 3a-3c are schematic diagrams of a historical time queue in different states according to an embodiment of the present disclosure.

FIG. 4 is a flowchart of a position determining method according to an embodiment of the present disclosure.

FIG. 5 is an operation flow chart of a position estimation model according to an embodiment of the present disclosure.

FIG. 6 is a schematic structural diagram of an electronic device according to an embodiment of the present disclosure

### DETAILED DESCRIPTION

It can be understood that prior to using the technical solutions disclosed in various embodiments of the present disclosure, users should be informed of the types, scope of use, use scenarios, etc. of personal information involved in the present disclosure in an appropriate way according to relevant laws and regulations, and authorization from users should be acquired.

For example, in response to receiving the user's active request, prompt information is sent to the user to clearly remind the user that the operation requested by the user will require for obtaining and using the user's personal information. Therefore, the user can independently choose whether to provide personal information to software or hardware such as electronic devices, application programs, servers or storage medium that perform the operation of the technical solution of the present disclosure according to the prompt information.

As an optional but non-limiting implementation, in response to receiving the user's active request, the way to send the prompt information to the user can be, for example, a pop-up window, in which the prompt information can be presented in text. Moreover, the pop-up window can also carry a selection control for the user to choose “agree” or “disagree” to provide personal information to the electronic device.

It can be understood that the above process of notifying and obtaining user's authorization is only for illustrative purpose, and is not intended to limit the implementation of the present disclosure. Other ways that satisfy relevant laws and regulations can also be applied to the implementation of the present disclosure.

It can be understood that the data involved in this technical solution (including but not limited to the data itself, data acquisition or use of data) shall comply with the requirements of corresponding laws, regulations and relevant regulations.

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth herein, but rather, these embodiments are provided for a more thorough and complete understanding of the present disclosure.

It should be understood that the drawings and embodiments of the present disclosure are only used for illustrative purposes, and are not used to limit the scope of protection of the present disclosure.

It should be understood that various steps described in the method embodiments of the present disclosure can be performed in parallel in the form of “and/or”. Furthermore, method embodiments may include additional steps and/or omit performing the illustrated steps. The scope of the present disclosure is not limited in this respect.

As used herein, the term “including/comprising” and its variants are open-ended inclusions, that is, “including/comprising but not limited to”. The term “based on” refers to” at least partially based on”. The term “one embodiment” refers to “at least one embodiment”; the term “another embodiment” refers to “at least one other embodiment”; the term “some embodiments” refers to “at least some embodiments”. Related definitions of other terms will be given in the following description.

It should be noted that the concepts of “first” and “second” mentioned in the present disclosure are only used to distinguish different devices, modules or units, and are not used to limit the order or interdependence of the functions performed by these devices, modules or units.

It should be noted that the modifications of “a” and “a plurality” mentioned in the present disclosure are schematic rather than limitative, and those skilled in the art should understand that unless the context clearly indicates otherwise, they should be understood as “one or more”.

Names of messages or information exchanged among multiple devices in the embodiments of the present disclosure are only used for illustrative purposes, and are not used to limit the scope of these messages or information.

Hereinafter, the technical solution provided by the embodiments of the present disclosure will be described in detail with reference to the accompanying drawings.

The Extended Reality (XR) technology in one or more embodiments of the present disclosure may be mixed reality technology, augmented reality technology and virtual reality technology. Extended reality technology can combine reality and virtuality through computers, providing users with an extended reality space for human-computer interaction. In the extended reality space, users can conduct social interaction, entertainment, studying, working, telecommuting, and create user generated content (UGC) through extended reality devices such as a head mount display (HMD).

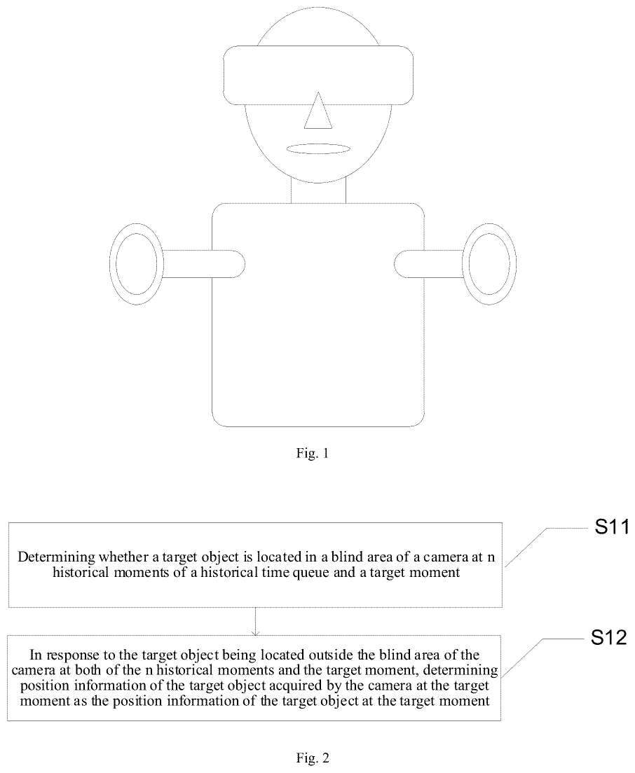

Referring to FIG. 1, a user can enter an extended reality space through an extended reality device such as a headset, and control his/her Avatar to conduct social interaction, entertainment, studying, telecommuting, etc., with Avatars controlled by other users in the extended reality space.

In an embodiment, in the extended reality space, the user can realize related interactive operations through a controller, which can be a handle, for example, the user controls related operations by operating the keys of the handle.

The extended reality devices recorded in the embodiments of the present disclosure may include, but be not limited to, the following several types:

Computer-side extended reality device uses a computer to perform related calculations and data output of extended reality functions, and external computer-side extended reality device uses the data output from the computer to achieve the extended reality effects.

Mobile expansion device supports setting up mobile terminals (such as smart phones) in various ways (such as head-mounted displays with special card slots). Through wired or wireless connection with the mobile terminals, the mobile terminals can perform related calculations on the extended reality functions and output data to the mobile extended reality device. For example, an extended reality video can be watched through an APP of the mobile terminals.

All-in-one extended reality device has a processor for related calculations of extended reality functions, and hence has independent, extended reality input and output functions without the need of connection with a computer or a mobile terminal; as a result, it has high freedom of usage.

Of course, the form of implementing the extended reality device is not limited to this, and can be further miniaturized or enlarged as needed.

The extended reality device is equipped with a posture detection sensor (such as a nine-axis sensor) to detect the posture change of the extended reality device in real time. If the user wears an extended reality device, when the posture of the user's head changes, the real-time posture of the head will be transmitted to the processor, so that the gaze point of the user's line of sight in the extended reality space environment can be calculated. According to the gaze point, the image in the user's gaze range (i.e. virtual field of view) in the three-dimensional model of the extended reality space environment is calculated, and displayed on a display screen, which provides an immersive experience that makes people feel as if they are watching in a real environment.

Handle tracking solutions can usually be classified into optical tracking (such as capturing with a camera) and integration based on inertial measurement unit. Optical tracking can provide high-precision position results, but when the handle moves to a blind area of the camera, optical tracking based on vision cannot give accurate position prediction. In addition, extended reality devices usually are run on embedded terminals, which are faced with resource constraints.

In the related art, the sensor is used to integrate the information such as speed and acceleration with time, so that a trajectory of the handle in the blind area of the camera is obtained. With the passage of time, IMU will accumulate errors due to temperature, noise and other reasons, which makes the final predicted position continuously shift to a certain direction, and the prediction result is completely unusable.

Based on a temporal network, such as Recurrent Neural Network (RNN), Long Short-Term Memory network (LSTM) and Gate Recurrent Unit (GRU), the time series is modeled, and the position prediction of the handle in the blind area of the camera is transformed into the problem of time series prediction. However, this method must keep information of hidden layers of the neural network model. In order to keep the information of hidden layers of the neural network model, it is necessary to perform position prediction of the handle outside the blind area of the camera, and the neural network model must keep running in both of the case where the handle is located inside the blind area of the camera and the case where the handle is located outside the blind area of the camera.

In some embodiments of the present disclosure, a position determining method is provided, as shown in FIG. 1, including the following steps:

S11, determining whether a target object is located in a blind area of a camera at n historical moments of a historical time queue and a target moment.

In some embodiments, the execution subject of the method provided in the present disclosure can be any extended reality device in the present disclosure, and the extended reality device can include a head-mounted display device and a matching handle (or a leg ring and other accessories that need to be positioned). Taking the handle as an example, the handle can be classified into a left-handed handle and a right-handed handle, and the target object can be the left-handed handle or the right-handed handle of the extended reality device. This method can be used to determine the position of the left-handed handle or the right-handed handle. The positions of the left-handed and right-handed handles are usually not strongly correlated, and hence are determined separately. In some embodiments, a historical time queue is set, and the historical time queue is used to store the historical position information of the target object at the latest n historical moments prior to the target moment, where n is a preset positive integer not less than 2, and n can be a positive integer not less than 10, 20, 30, 40 or 50, for example, 60. Historical position information is the position information of the target object at historical moments, and in some embodiments, the position information can be obtained periodically. The latest n historical moments can be historical moments of n cycles prior to the target moment; for example, 30 cycles can be set in one second, and n can be 60, so the historical time queue can be historical moments within 2 seconds prior to the target moment. In some embodiments, the historical moments and the target moment can be frame acquisition moments when a camera captures an image. The camera can be located on the head-mounted display device of the extended reality device, and the target object (handle) has light spots for positioning. The camera captures the light spots on the handle to obtain the 6-degree-of-freedom information (position and angle, etc.) of the target object. The camera can periodically capture images, for example, 30 frames of images in one second, and can acquire the posture change information of the target object when capturing images. Therefore, each historical moment and the target moment are also frame acquisition moments of capturing an image, and each frame of image captured by the camera corresponds to the posture change information and the position information of the target object. In some embodiments, when the position information of the handle depends on the position information of the head-mounted display device, the historical time queue also contains the position information such as the position, speed, angle, acceleration and/or angular velocity information of the head-mounted display device at the historical moments. In some embodiments, the target object being located in the blind area of the camera means that the camera can't capture the target object. In some other embodiments, the target object being located in the blind area of the camera may also mean that although the camera can capture the target object, the captured image can't be used to determine the position information of the target object (e.g., due to lack of clarity, insufficient number of light spots, etc.), which is also considered as the target object being located in the blind area of the camera.

S12, in response to the target object being located outside the blind area of the camera at both of the n historical moments and the target moment, determining position information of the target object acquired by the camera at the target moment as the position information of the target object at the target moment.

In some embodiments, when the target object is outside the blind area of the camera at both of the n historical moments and the target moment, it indicates that the target object has been in the position that can be captured by the camera and has been in the position that can be captured by the camera for a certain period of time. At this time, the position information of the target object can be determined by the image captured by the camera at the target moment, and it is not necessary to determine the position information of the target object at the target moment according to the historical time queue and the posture change information. For example, in some embodiments, the neural network model is used to determine the position information of the target object at the target moment according to the historical time queue and the posture change information, but when the target object is outside the blind area of the camera at both of the n historical moments and the target moment, the neural network model will not work.

According to the method provided in some embodiments of the present disclosure, when the target object is outside the blind area of the camera at both of the n historical moments and the target moment, the position information acquired by the camera at the target moment is used as the position information of the target object at the target moment, so that the problem of shift deviation caused by integrating the sensor information for a long time can be avoided.

In some embodiments of the present disclosure, the method further includes: acquiring posture change information of the target object at the target moment; and in response to the target object being located in the blind area of the camera at least at one of the n historical moments and the target moment, determining the position information of the target object at the target moment according to the historical time queue and the posture change information.

In some embodiments, acquiring the posture change information may be performed prior to or after step S11. In a case where the method is used for an extended reality device by way of example, both the handle and the head-mounted display device can be provided with posture sensors, such as one or more of acceleration sensors and angular velocity sensors. Sensor information (e.g., one or more of acceleration information and angular velocity information) acquired from the posture sensors can be used as the posture change information, or feature extraction can be performed on the sensor information (e.g., by integrating, in which the integration time is from the target moment to the last historical moment) to obtain the posture change information. For example, the posture change information may include the speed, angle, acceleration and/or angular velocity of the target object. In some embodiments, in the extended reality device, the head-mounted display device can be used as the origin of the space, and the position of the handle can be a position which depends on the head-mounted display device. At this time, since the posture change information of the handle depends on the head-mounted display device, the posture change information of the handle needs to contain posture data such as the position, speed, angle, acceleration and/or angular velocity of the head-mounted display device. In some embodiments, the camera periodically captures images, and the moment when capturing an image refers to a frame acquisition moment, and the target moment can be the frame acquisition moment of the latest captured image, that is, the latest moment (including the current moment) when the camera captured an image prior to the current moment. Therefore, the posture change information refers to the information of posture change of the target object during the period from the latest captured image to a previous captured image prior to the latest captured image.

In some embodiments, when the target object is located in the blind area of the camera at the historical moment or the target moment, the position information of the target object at the target moment is predicted by using n pieces of historical position information in the historical time queue and the posture change information at the target moment. For example, the n pieces of historical position information and the posture change information at the target moment can be input into the neural network model, so as to output the position information. The output position information of the target object at the target moment can be a relative position of the target object at the target moment relative to a position of the target object at a previous historical moment prior to the target moment. It is difficult to determine an absolute position in the blind area of the camera, but it is simpler to determine a relative position relative to the latest historical moment prior to the target moment, which is more suitable for equipment with less computing power resources. Kalman filter can be used to improve the accuracy of the determined position information.

In some embodiments of the present disclosure, a historical time queue is set to save the position information of the target object at n historical moments; when the target object is outside the blind area of the camera at both of the target moment and the historical moments, the position information of the target object is determined by using the optical tracking of the camera, instead of always calculating the position information of the target object by using the neural network model; and when the target object is located in the blind area of the camera at the target moment or n historical moments, the historical time queue is used to predict the position information at the target moment.

In some embodiments of the present disclosure, after determining that the target object is located in the blind area of the camera at least at one of the n historical moments and the target moments, determining the position information of the target object at the target moment according to the historical time queue and the posture change information by using a position estimation model; and after determining that the target object is located outside the blind area of the camera at both of the n historical moments and the target moment, maintaining or setting the position estimation model in a non-working state.

In some embodiments, the traditional temporal networks such as LSTM and GRU need to use data of hidden layers to calculate the position information in the blind area of the camera. As a result, temporal networks need to calculate the position information of the target object all the time no matter where the target object is located. In the present disclosure, it is not necessary to always use a position prediction model (such as a neural network model) to predict the position information of the target object. When the target object is not in the blind area of the camera at both the target moment and the historical moments, it's not necessary to use the position estimation model and the position estimation model will not work, and it is not necessary to input the historical time queue and the posture change information into the position estimation model, which will work only when the target object is in the blind area of the camera. In this way, it can reduce the consumption of resources. In addition, according to the present disclosure, when the target object is in the blind area of the camera, the predicted position information makes a reference to the historical position information of n historical moments, instead of only relying on the posture change information, thus preventing the position information from deviating.

In some embodiments, after the position information of the target object is determined, the historical time queue can be updated, and the position information of the target object at the target moment is put into the historical time queue according to the principle of first-in first-out, and the position information of the target object at the earliest historical moment in the historical time queue is removed.

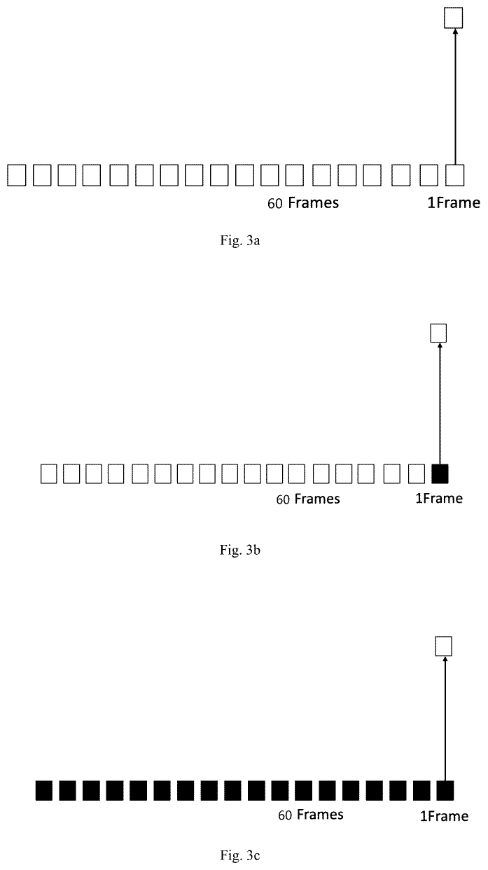

In order to better explain the embodiments of the present disclosure, an exemplary embodiment is provided below. The execution subject of the method in this embodiment is an extended reality device. Firstly, information of posture sensors of the handle and the head-mounted display device of the extended reality device at the current moment is acquired, and then feature extraction is carried out to obtain the posture change information (the speed and angular velocity of the left-handed and right-handed handles, the position and angular velocity of the head-mounted display, etc.). The head-mounted camera captures 30 frames of images in one second. The historical time queue includes: the position information of the handle corresponding to 60 historical moments when the camera captured images in previous 2 seconds, that is, the position information corresponding to 60 frames of images in the previous 2 seconds. In a case where the current moment is used as the target moment, for example, if the handle is located in the area where the camera of the head-mounted display device can capture images at both of the current moment and the 60 historical moments in the previous 2 seconds (i.e., the handle is outside the blind area of the camera, as shown in FIG. 3a, the blank box indicates that the handle is located outside the blind area of the camera at the moment when the camera captures an image, and the box pointed by the arrow is the position information that needs to be determined at the moment when a latest frame of image was captured), the position information of the handle is determined by the image of the handle captured by the camera without using the neural network model for prediction, and then the historical time queue is updated according to the principle of first-in first-out. For example, the handle has positioning light spots, and the position information of the handle is determined by the positioning light spots. If the handle is located in the area where the camera of the head-mounted display device can't capture an image at least at one moment of the current moment and the 60 historical moments in the previous 2 seconds (i.e., the handle is in the blind area of the camera, as shown in FIGS. 3b and 3c, the black box indicates that the handle is located in the blind area of the camera at the moments when the camera captures images), the posture change information and the historical time queue are input into the neural network model, and the predicted position information of the handle is output. In order to improve the prediction accuracy of the model, the output can be optimized by Kalman filter, and the historical time queue can be updated. The output position information is a relative position of the target object at the current moment relative to a position thereof at the latest historical moment. In the embodiment of the present disclosure, the camera periodically acquires images at 30 frames per second, and the position information corresponding to the latest one frame of image is predicted through the position information corresponding to the historical, 60 frames of images, thus avoiding the problem that the predicted trajectory may have a deviation when located in the blind area of the camera for a long time. Moreover, the neural network model is not always in the working state, instead, it does not work when the target object is outside the blind area of the camera, which reduces the occupation of resources and is more suitable for embedded devices.

In some embodiments of the present disclosure, after determining that the target object is located in the blind area of the camera at least at one moment of the n historical moments and the target moment, and prior to determining the position information of the target object at the target moment according to the historical time queue and the posture change information, the method further includes: ending the method in response to the target object entering the blind area of the camera for a first time and the number of the historical position information not reaching n.

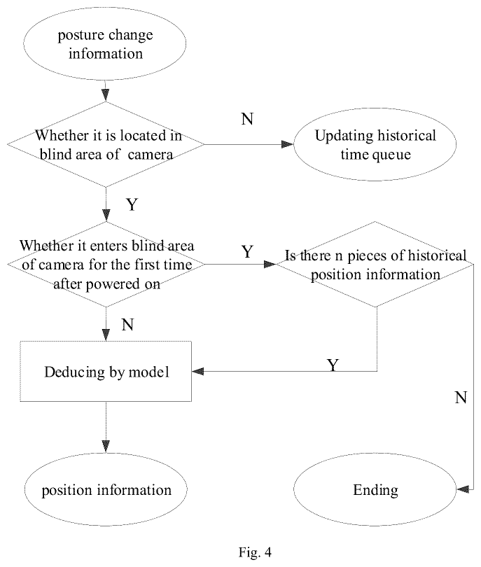

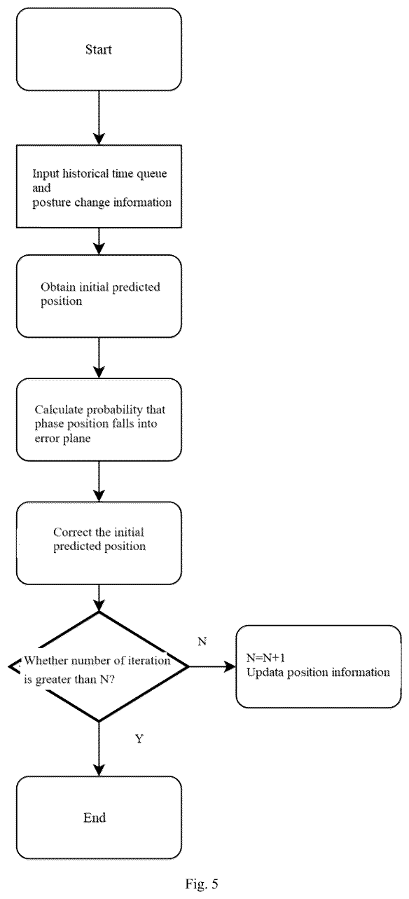

In some embodiments, as shown in FIG. 4, after acquiring the posture change information, firstly, it can be determined whether the target object is in the blind area of the camera at the historical moments and the target moment. If the target object is not located in the blind area of the camera at both the historical moments and the target moment, the position information of the target object at the target moment will be determined according to the captured image, and then the historical time queue will be updated with the determined position information. If the target object is in the blind area of the camera at the historical moment or the target moment, it will be judged whether it's the first time for the target object to enter the blind area of the camera after the equipment executing the method (e.g., the extended reality device) is powered on. If it is not the first time for the target object to enter the blind area of the camera, it indicates that enough position information of the target object has been accumulated, and then the position information of the target object at the target moment will be determined according to the historical time queue and the posture change information. If it is the first time for the target object to enter the blind area of the camera, it can be determined whether the number of historical position information stored in the historical time queue reaches n; if the number reaches n, the position information of the target object at the target moment is determined according to the historical time queue and the posture change information, or if the number does not reach n, the method is ended. In some embodiments, as shown in FIG. 4, if it's the first time for the target object to enter the blind area of the camera after the equipment is powered on, it may not have accumulated enough historical position information. At this time, firstly, it is determined whether there are n pieces of historical position information in the historical time queue, because it may involve the case where the historical time queue is not stored with n pieces of historical position information after the equipment is powered on. If the historical time queue is not stored with n pieces of historical position information, there is not enough information to ensure the accuracy of the predicted position information. In such case, the method provided in the embodiment of the present disclosure is not executed. If there is enough historical position information, for example, a neural network model can be used to predict the position information of the target object at the target moment.

In some embodiments of the present disclosure, determining the position information of the target object at the target moment according to the historical time queue and the posture change information includes: determining a relative position of the target object at the target moment relative to a previous historical moment according to the historical time queue and the posture change information, and determining the relative position as the position information of the target object at the target moment. Alternatively, determining a relative position of the target object at the target moment relative to a previous historical moment according to the historical time queue and the posture change information, and determining the position information of the target object at the target moment according to the relative position and the historical position information of the target object at the previous historical moment.

In some embodiments, when the target object is in the blind area of the camera, it is relatively difficult to determine the absolute position of the target object, which will consume more resources and time, with poor timeliness. Therefore, the output position information is a relative position of the target object relative to a previous historical moment prior to the target moment, which is the closest historical moment, in terms of time, prior to the target moment. A previous historical moment refers to a historical moment prior to the target moment. In some other embodiments, the position information of the target moment can be obtained by adding the determined relative position to the historical position information of the previous historical moment, and the obtained position information can be an absolute position (e.g., the absolute position is expressed by spatial coordinates).

In some embodiments of the present disclosure, determining the position information of the target object at the target moment according to the historical time queue and the posture change information includes:
inputting n pieces of historical position information in the historical time queue and the posture change information into a position estimation model to obtain an initial predicted position;
performing at least one iteration on the initial predicted position, and determining a probability that a phase position predicted in each iteration phase by the position estimation model falls into each error plane, wherein a distribution of each error plane has a corresponding error expectation;
correcting the initial predicted position according to the probability that the phase position predicted in each iteration phase falls into each error plane and the error expectation corresponding to the error plane, to obtain a corrected predicted position; and
determining the corrected predicted position as the position information of the target object at the target moment.

In some embodiments, as shown in FIG. 5, when determining the position information of the target object at the target moment, the historical time queue and posture change information are input into the position estimation model, and the initial predicted position P_{coarse} is obtained. This is a coarse position, which is used as the starting point of the subsequent iteration phase; and this position is different from the real position information, so it is iterated for one or more times. The input of the first iteration phase is the initial predicted position, and the input of the subsequent iteration phase is the phase position output from the previous iteration phase. The iteration phase is used to perform a displacement (residual expectation) on the input position, and the sum of the displacement and the input position of the iteration phase is taken as the output position of the iteration phase, and the output of the iteration phase is also the position information of the target object at the target moment predicted in the iteration phase, that is, the phase position. There is an error in the phase position, and the calculation of the error of the phase position is converted into the calculation of an error plane in the present disclosure. An error plane is a two-dimensional or three-dimensional plane that predicts errors, and the error plane corresponds to an error expectation. After determining the error plane into which the phase position falls, the error expectation corresponding to the error plane can be used to determine the residual expectation of the phase position. Therefore, in the embodiment of the present disclosure, if a preset number of N iteration phases are performed, there are residual expectations in N iteration phases, and the initial predicted position is corrected by these residual expectations, and the obtained corrected predicted position is also the position information of the target object at the target moment determined by the position estimation model.

In some embodiments of the present disclosure, the initial predicted position is corrected according to the probability that the phase position predicted in each iteration phase falls into each error plane and the error expectation corresponding to the error plane, including: correcting the initial predicted position by using the following Formula 1:

$${P}_{true} = {P}_{coarse} + {\sum }_{i = 1}^{N} {λ}_{i} ( {\sum }_{j = 1}^{P} ( {x}_{j} \cdot {p}_{j} ) ) .$$

In Formula 1, Pₜᵣᵤₑ is the corrected prediction position, P_{coarse} is the initial predicted position, N is the number of iteration phases, λᵢ is the weight of the i^{th} iteration phase, P is the number of error planes, xⱼ is the error expectation of the j^{th} error plane, and Pⱼ is the probability that the phase position of the i^{th} iteration phase falls into the j^{th} error plane.

In some embodiments, as shown in Formula 1, at any iteration phase, the probability that the phase position output by the iteration phase falls into each error plane Pⱼ is calculated, and then the corresponding probability is multiplied with the corresponding error expectation xⱼ and accumulated and summed to obtain the residual expectation of the iteration phase; each iteration phase has a corresponding weight λᵢ, and the residual expectations of various iteration phases are weighted and summed, so that the deviation of the whole position estimation model is obtained; then the initial predicted position is corrected by using this deviation, so that the corrected predicted position is obtained.

In some embodiments of the present disclosure, prior to step S11, there is also a step of pre-training the position estimation model. Pre-training is a process of training the model by using a large number of pieces of data with known results, so that the deviation between the predicted position output by the model and the real position is minimized. Generally, this process usually needs to carry out multiple iteration phases and constantly adjust the model parameters to minimize a loss function of the position estimation model.

In some embodiments of the present disclosure, the position estimation model is pre-trained in the following ways:
inputting training data into the position estimation model to obtain an initial estimated position;
performing at least one pre-training iteration phase on the initial estimated position, wherein in the pre-training iteration phase: determining an error plane prediction model according to a residual error between a real position of the training data and an input position of the pre-training iteration phase, wherein an input of the error plane prediction model is a position, and an output of the error plane prediction model is an error expectation corresponding to the input position; and determining a residual expectation of the position estimation model in the pre-training iteration phase according to the error plane prediction model and a probability distribution function of the pre- training iteration phase;
determining a loss function of the position estimation model according to the residual expectation of each pre-training iteration phase; and
adjusting parameters of the position estimation model to reduce the loss function of the position estimation model.

In some embodiments, in the pre-training process, the training data may include historical position information and posture change information obtained in advance, and the real position corresponding to the training data is known. In the pre-training stage, the following steps 1 to 5 may be executed, for example.

Step 1: inputting the training data into the position estimation model to get an initial estimated position, which is as same as the process of obtaining the initial predicted position described above.

Step 2: taking a difference between the real position and the input position in the pre-training iteration phase as a residual error, and determining the error plane prediction model by using a distribution of the residual error, wherein the error plane prediction model can tell the error expectations at different positions.

According to the embodiment, the pre-training iteration phases are the repeated steps 2 and 3, the input position of the first pre-training iteration phase is the initial estimated position, and a residual expectation will be determined in the pre-training iteration phase, and the sum of the input position of one pre-training iteration phase plus the residual expectation of this iteration phase will be used as the input position of the next pre-training iteration phase. Through this step, the problem of calculating residual expectation in iteration phase is transformed into the problem of predicting error plane.

Step 3, determining a residual expectation of the position estimation model in the pre-training iteration phase according to the error plane prediction model and a probability distribution function of the pre-training iteration phase.

According to the embodiment, an input of the probability distribution function is the position, and an output of the probability distribution function is the probability that the pre-training iteration phase is located at the input position. For example, the residual expectation in the pre-training iteration phase is calculated by using the following Formula 2:

$$E ( Res ) = \int [ E ( x ) ⋆ P ( x ) ] dx .$$

In Formula 2, E(Res) is the residual expectation of the calculated pre-training iteration phase, x is the position, E(x) is the error expectation of the error plane where the position x is located, the asterisk in Formula 2 represents multiplication, P(x) is the probability that the calculated pre-training iteration phase is located at the position x, and the integral interval is the whole space. Formula 2 can be expressed as below: for each position x, the error expectation E(x) of the error plane is multiplied by the probability distribution P(x) at that position, and then the whole space is integrated. It is equivalent to multiplying the error expectation of each position by its corresponding probability, and adding up the products of all positions to get the residual expectation of this iteration phase.

Step 4: calculating a loss function.

According to the embodiment, the loss function of the position estimation model is determined according to the residual expectation of each pre-training iteration phase, including:
the loss function of the position estimation model is calculated by the following Formula 3:

$${ℒ}_{all} = {\sum }_{i = 1}^{N} {λ}_{i} \cdot {E ( Res )}_{i} .$$

In Formula 3, Lₐₗₗ represents the loss function of the position estimation model, N represents the number of pre-training iteration phases, that is, the number of times that Step 2 and Step 3 are repeatedly executed, and N can be set as 10, λᵢ represents the weight of the residual expectation of the i^{th} pre-training iteration phase, and E (Res) i represents the residual expectation of the i^{th} pre-training iteration phase. Through multiplying the residual expectation of each pre-training iteration phase by the corresponding weight, and weighting and summing the products, it can comprehensively consider the importance and contribution of different iteration phases and construct a comprehensive loss function. The weight parameter λᵢ is used to control the relative importance of residual expectation in each iteration phase, which can be adjusted according to specific needs. The weights and/or number of iteration phases determined when the position estimation model is pre-trained may be the same as the weights and/or number of iteration phases when the position estimation model is used (i.e., when the position information of the target object at the target moment is determined). The weight of a preceding iteration phase is greater than that of a subsequent iteration phase. In some embodiments, λᵢ=0.5×λ₍ᵢ₋₁₎, which indicates that the weights decrease in turn, and is consistent with the learning process from coarse to fine.

Step 5: adjusting the parameters of the position estimation model to minimize the loss function.

According to the embodiment, after adjusting the position estimation model, repeating steps 1 to 4 to determine the adjusted loss function, and continuously adjusting the parameters synchronously to minimize the loss function, so that the parameters of the model can be optimized, and that the model can achieve better performance in multiple stages, and the task requirements of various stages are comprehensively taken into consideration. This can improve the overall performance and generalization ability of the model to be adapted to the training process of different levels and objectives.

In some embodiments of the present disclosure, the method as provided can be conveniently deployed on embedded end-side hardware. In order to reduce the occupation of memory and computing resources, the fixed-length time series queue with limited length outside and inside the blind area of the camera is optimized.

The method provided in the present disclosure allows the position estimation model to make continuous position prediction at any time, and has high tolerance for frame loss. The traditional method of predicting a blind spot of the handle usually performs position prediction at a fixed time interval; as comparison, in the present technical solution, the prediction can be immediately performed when needed, which realizes more real-time and continuous prediction ability. This highly flexible reasoning mechanism enables the network to be better adapted to different operating scenarios and changes in input, and provide more accurate blind spot prediction results.

According to the method provided in the present disclosure, when the target object is out of the blind area of the camera for a long time, the position estimation model does not need to perform position prediction, so that the power consumption can be effectively reduced. In the traditional solution, even if the handle is always outside the blind area of the camera, the neural network will continue to predict the position, thus wasting a lot of computing resources and energy. As comparison, the present disclosure intelligently judges whether the target object is in the blind area of the camera, and only performs prediction when necessary, thus reducing the power consumption to the greatest extent and prolonging the battery life of embedded equipment.

The traditional blind spot prediction solution needs to store the intermediate data of the hidden layers. In the method provided by the present disclosure, when the target object is outside the blind area of the camera at the historical moments and the current moment, the position estimation model does not work, so there is no such situation that the position information predicted by the position estimation model at this moment is stored, thus reducing the storage amount of data. In the method provided by the present disclosure, the historical time queue and the posture change information can be stored in the memory, to prevent from the influence on data accuracy (when using heterogeneous hardware such as embedded neural network processor to quantize a neural network model, floating-point data will become fixed-point data, resulting in decrease of accuracy).

The method provided in the embodiment of the present disclosure can be combined with other algorithms. Especially, this method can be combined with time convolution, temporal network, extended Kalman filter, discrete Kalman filter, unscented Kalman filter, Lagrange Kalman filter and other algorithms.

The present disclosure also provides a position determining apparatus, including:
a control unit, configured to determine whether a target object is located in a blind area of a camera at n historical moments of a historical time queue and a target moment; wherein the historical time queue is configured to store historical position information of the target object at latest n historical moments prior to the target moment, where n is a preset positive integer not less than 2;
the control unit is further configured to determine position information of the target object at the target moment acquired by the camera as the position information of the target object at the target moment in response to the target object being located outside the blind area of the camera at both of the n historical moments and the target moment.

In some embodiments, the apparatus further includes an acquisition unit configured to acquire the posture change information of the target object at the target moment.

The control unit is further configured to determine the position information of the target object at the target moment according to the historical time queue and the posture change information in response to the target object being located in the blind area of the camera at least at one of the n historical moments and the target moment.

After determining that the target object is located in the blind area of the camera at least at one moment of the n historical moments and the target moment, and prior to determining the position information of the target object at the target moment according to the historical time queue and the posture change information, the control unit is further configured to end the method in response to the target object entering the blind area of the camera for the first time and the number of the historical position information not reaching n.

In some embodiments, determining the position information of the target object at the target moment according to the historical time queue and the posture change information includes:
determining the relative position of the target object at the target moment relative to the previous historical moment according to the historical time queue and the posture change information, and taking the relative position as the position information of the target object at the target moment; or,
determining the relative position of the target object at the target moment relative to the previous historical moment according to the historical time queue and the posture change information, and determining the position information of the target object at the target moment according to the relative position and the historical position information of the target object at the previous historical moment.

In some embodiments, after determining that the target object is located in the blind area of the camera at least at one moment of the n historical moments and the target moment, the control unit is configured to determine the position information of the target object at the target moment according to the historical time queue and the posture change information by using a position estimation model;
after determining that the target object is located outside the blind area of the camera at both of the n historical moments and the target moment, the control unit is further configured to maintain or set the position estimation model in a non-working state.

In some embodiments, determining the position information of the target object at the target moment according to the historical time queue and the posture change information includes:
inputting n pieces of historical position information in the historical time queue and the posture change information into the position estimation model to obtain an initial predicted position;
performing at least one iteration on the initial predicted position;
determining a probability that a phase position predicted in each iteration phase by the position estimation model falls into each error plane, wherein a distribution of each error plane has a corresponding error expectation;
correcting the initial predicted position according to the probability that the phase position predicted in each iteration phase falls into each error plane and the error expectation corresponding to the error plane, to obtain a corrected predicted position; and
using the corrected predicted position as the position information of the target object at the target moment.

In some embodiments, the initial predicted position is corrected according to the probability that the phase position predicted in each iteration phase falls into each error plane and the error expectation corresponding to the error plane, including: correcting the initial predicted position by using the following Formula 1:

$${P}_{true} = {P}_{coarse} + {\sum }_{i = 1}^{N} {λ}_{i} ( {\sum }_{j = 1}^{P} ( {x}_{j} \cdot {p}_{j} ) ) .$$

In Formula 1, Pₜᵣᵤₑ is the corrected prediction position, P_{coarse} is the initial predicted position, N is the number of iteration phases, λᵢ is the weight of the i^{th} iteration phase, P is the number of error planes, xⱼ is the error expectation of the j^{th} error plane, and Pⱼ is the probability that the phase position of the i^{th} iteration phase falls into the j^{th} error plane.

In some embodiments, the position estimation model is pre-trained in the following ways:
inputting training data into the position estimation model to obtain an initial estimated position;
performing at least one pre-training iteration phase on the initial estimated position, wherein in the pre-training iteration phase: determining an error plane prediction model according to a residual error between a real position of the training data and an input position of the pre-training iteration phase, wherein an input of the error plane prediction model is a position, and an output of the error plane prediction model is an error expectation corresponding to the input position; and determining a residual expectation of the position estimation model in the pre-training iteration phase according to the error plane prediction model and a probability distribution function of the pre-training iteration phase, wherein an input of the probability distribution function is a position, and an output of the probability distribution function is a probability that the pre-training iteration phase is located at the input position;
determining a loss function of the position estimation model according to the residual expectation of each pre-training iteration phase; and
adjusting parameters of the position estimation model to reduce the loss function of the position estimation model.

In some embodiments, determining the residual expectation of the position estimation model in the pre-training iteration phase according to the error plane prediction model and the probability distribution function of the pre-training iteration phase includes:
calculating the residual expectation in the pre-training iteration phase by the following Formula 2:

$$E ( Res ) = \int [ E ( x ) ⋆ P ( x ) ] dx .$$

In Formula 2, E(Res) is the residual expectation of the calculated pre-training iteration phase, x is the position, E(x) is the error expectation of the error plane where the position x is located, P(x) is the probability that the calculated pre-training iteration phase is at the position x, and the integral interval is the whole space.

In some embodiments, determining the loss function of the position estimation model according to the residual expectation of each pre-training iteration phase includes:
calculating the loss function of the position estimation model by using the following Formula 3:

$${ℒ}_{all} = {\sum }_{i = 1}^{N} {λ}_{i} \cdot {E ( Res )}_{i} .$$

In Formula 3, Lₐₗₗ represents the loss function of the position estimation model, N represents the number of pre-training iteration phases, λᵢ represents the weight of the residual expectation of the i^{th} pre-training iteration phase, and E(Res)ᵢ represents the residual expectation of the i^{th} pre-training iteration phase.

In some embodiments, the weight of a preceding iteration phase is greater than that of a subsequent iteration phase.

For relevant portions of the apparatus embodiments basically corresponding to the method embodiments, reference can be made to the corresponding description of the method embodiments. The apparatus embodiments described above are only for illustrative purposes, in which the modules described as separate modules may or may not be separate. Some of or all the modules can be selected according to actual needs to achieve the purpose of these embodiment. Those ordinary skilled in the art can understand and implement the present disclosure without creative labor.

As above, the method and apparatus of the present disclosure have been described based on embodiments and application examples. Moreover, the present disclosure also provides an electronic device and a computer-readable storage medium, which are described below.

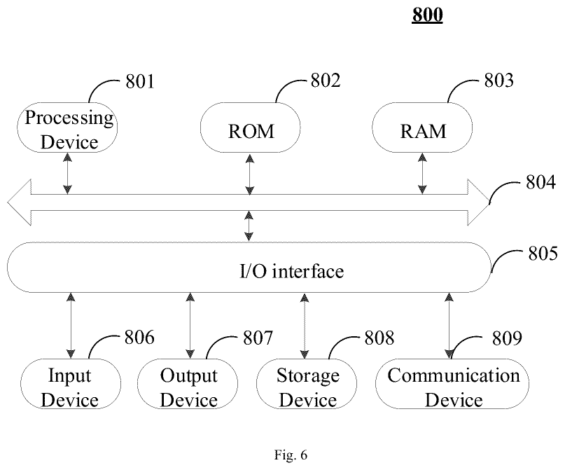

Reference is now made to FIG. 6, which shows a schematic structural diagram of an electronic device (such as a terminal device or a server) 800 suitable for implementing an embodiment of the present disclosure. The terminal devices in the embodiment of the present disclosure may include, but are not limited to, mobile terminals such as mobile phones, notebook computers, digital broadcast receivers, PDA (Personal Digital Assistant), PAD (Tablet Computer), PMP (Portable Multimedia Player) and vehicle-mounted terminals (such as vehicle-mounted navigation terminals); and fixed terminals such as digital TVs and desktop computers. The electronic device shown in the figure is only an example, and should not bring any limitation to the function and application scope of the disclosed embodiment.

The electronic device 800 may include a processing device (such as a central processing unit, a graphics processor, etc.) 801, which may perform various appropriate actions and processes according to a program stored in a read-only memory (ROM) 802 or a program loaded from a storage device 808 into a random-access memory (RAM) 803. In the RAM 803, various programs and data required for the operation of the electronic device 800 are also stored. The processing device 801, the ROM 802 and the RAM 803 are connected to each other through a bus 804. An input/output (I/O) interface 805 is also connected to the bus 804.

Generally, the following devices can be connected to the I/O interface 805: an input device 806 including, for example, a touch screen, a touch pad, a keyboard, a mouse, a camera, a microphone, an accelerometer, a gyroscope, etc.; an output device 807 including, for example, a liquid crystal display (LCD), a speaker, a vibrator, etc.; a storage device 808 such as a magnetic tape, a hard disk, etc.; and a communication device 809. The communication device 809 may allow the electronic device 800 to have wireless or wired communication with other devices to exchange data. Although the electronic device 800 with various devices is shown in the figure, it should be understood that it is not required to implement or have all the devices as shown. More or fewer devices may alternatively be implemented or provided.

In particular, according to an embodiment of the present disclosure, the process described above with reference to the flowchart can be implemented as a computer software program. For example, an embodiment of the present disclosure includes a computer program product, which includes a computer program carried on a computer-readable medium, and the computer program contains program codes for executing the method shown in the flowchart. In such an embodiment, the computer program can be downloaded and installed from the network through the communication device 809, or installed from the storage device 808, or installed from the ROM 802. When the computer program is executed by the processing device 801, the above functions defined in the method embodiments of the present disclosure are performed.

It should be noted that the computer-readable medium mentioned above in the present disclosure can be a computer-readable signal medium or a computer-readable storage medium or any combination of the two. The computer-readable storage medium can be, for example, but not limited to, an electrical, magnetic, optical, electromagnetic, infrared, or semiconductor system, apparatus or device, or a combination of any of the above. Examples of the computer-readable storage medium may include, but are not limited to, an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium can be any tangible medium containing or storing a program, which can be used by or in combination with an instruction execution system, apparatus or device. In the present disclosure, a computer-readable signal medium may include a data signal propagated in baseband or as part of a carrier wave, in which computer-readable program codes are carried. This propagated data signal can take many forms, including but not limited to electromagnetic signals, optical signals or any suitable combination of the above. A computer-readable signal medium can also be any computer-readable medium other than a computer-readable storage medium, which can send, propagate or transmit a program for use by or in connection with an instruction execution system, apparatus or device. The program codes contained in the computer-readable medium can be transmitted by any suitable medium, including but not limited to: electrical wires, optical cables, RF (radio frequency) and the like, or any suitable combination of the above.

In some embodiments, the client and the server can communicate by using any currently known or future developed network protocol such as HTTP (HyperText Transfer Protocol), and can be interconnected with digital data communication in any form or medium (for example, communication network). Examples of communication networks include a local area network (“LAN”), a wide area network (“WAN”), the Internet (for example, the Internet) and end-to-end networks (for example, ad hoc peer-to-peer networks), as well as any currently known or future developed networks.

The computer-readable medium may be included in the electronic device; or it can exist alone without being assembled into the electronic device.

The computer-readable medium carries one or more programs, which, when executed by the electronic device, enable the electronic device to perform the above method.

Computer program codes for performing the operations of the present disclosure may be written in one or more programming languages or their combinations, including but not limited to object-oriented programming languages, such as Java, Smalltalk, C++, and conventional procedural programming languages, such as “C” language or similar programming languages. The program code can be completely executed on the user's computer, partially executed on the user's computer, executed as an independent software package, partially executed on the user's computer and partially executed on a remote computer, or completely executed on a remote computer or server. In the case involving a remote computer, the remote computer may be connected to a user computer through any kind of network, including a local area network (LAN) or a wide area network (WAN), or may be connected to an external computer (for example, through the Internet using an Internet service provider).

The flowcharts and block diagrams in the drawings illustrate the architecture, functions and operations of possible implementations of systems, methods and computer program products according to various embodiments of the present disclosure. In this regard, each block in the flowchart or block diagram may represent a module, a program segment, or a part of code that contains one or more executable instructions for implementing specified logical functions. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, can be implemented by a dedicated hardware-based system that performs specified functions or operations, or by a combination of dedicated hardware and computer instructions.

The units involved in the embodiments described in the present disclosure can be realized by software or hardware. Among them, the name of the unit does not constitute any limitation of the unit itself in some cases.

The functions described above herein may be at least partially performed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine-readable medium may be a tangible medium that may contain or store a program for use by or in connection with an instruction execution system, apparatus or device. The machine-readable medium may be a machine-readable signal medium or a machine-readable storage medium. A machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more lines, a portable computer disk, a hard disk, a random-access memory (RAM), a read-only memory (ROM), an erasable programmable read-only memory (EPROM or flash memory), an optical fiber, a convenient compact disk read-only memory (CD-ROM), an optical storage device, a magnetic storage device, or any suitable combination of the above.

According to one or more embodiments of the present disclosure, there is provided a position determining method, including:
determining whether a target object is located in a blind area of a camera at n historical moments of a historical time queue and a target moment; wherein the historical time queue is configured to store historical position information of the target object at latest n historical moments prior to the target moment, where n is a preset positive integer not less than 2; and
in response to the target object being located outside the blind area of the camera at both of the n historical moments and the target moment, determining position information of the target object acquired by the camera at the target moment as the position information of the target object at the target moment.

According to one or more embodiments of the present disclosure, there is provided a position determining method, further including:
acquiring posture change information of the target object at the target moment; and
in response to the target object being located in the blind area of the camera at least at one moment of the n historical moments and the target moment, determining the position information of the target object at the target moment according to the historical time queue and the posture change information.

According to one or more embodiments of the present disclosure, there is provided a position determining method, in which after determining that the target object is located in the blind area of the camera at least at one moment of the n historical moments and the target moment, and prior to determining the position information of the target object at the target moment according to the historical time queue and the posture change information, further including:
in response to the target object entering the blind area of the camera for a first time and a number of the historical position information not reaching n, ending the method.

According to one or more embodiments of the present disclosure, there is provided a position determining method, in which determining the position information of the target object at the target moment according to the historical time queue and the posture change information, including:
determining a relative position of the target object at the target moment relative to a previous historical moment according to the historical time queue and the posture change information, and determining the relative position as the position information of the target object at the target moment; or,
determining the relative position of the target object at the target moment relative to the previous historical moment according to the historical time queue and the posture change information, and determining the position information of the target object at the target moment according to the relative position and historical position information of the target object at the previous historical moment.

According to one or more embodiments of the present disclosure, there is provided a position determining method, including: after determining that the target object is located in the blind area of the camera at least at one moment of the n historical moments and the target moment, determining the position information of the target object at the target moment according to the historical time queue and the posture change information by using a position estimation model; and
after determining that the target object is located outside the blind area of the camera at both of the n historical moments and the target moment, maintaining or setting the position estimation model in a non-working state.

According to one or more embodiments of the present disclosure, there is provided a position determining method, in which determining the position information of the target object at the target moment according to the historical time queue and the posture change information, including:
inputting n pieces of historical position information in the historical time queue and the posture change information into a position estimation model to obtain an initial predicted position;
performing at least one iteration on the initial predicted position;
determining a probability that a phase position predicted in each iteration phase by the position estimation model falls into each error plane, wherein a distribution of each error plane has a corresponding error expectation; and
correcting the initial predicted position according to the probability that the phase position predicted in each iteration phase falls into each error plane and the error expectation corresponding to the error plane, to obtain a corrected predicted position; and
determining the corrected predicted position as the position information of the target object at the target moment.

According to one or more embodiments of the present disclosure, there is provided a position determining method, in which correcting the initial predicted position according to the probability that the phase position predicted in each iteration phase falls into each error plane and the error expectation corresponding to the error plane, including: correcting the initial predicted position by using the following Formula 1:

$${P}_{true} = {P}_{coarse} + {\sum }_{i = 1}^{N} {λ}_{i} ( {\sum }_{j = 1}^{P} ( {x}_{j} \cdot {p}_{j} ) ) .$$

In Formula 1, Pₜᵣᵤₑ is the corrected prediction position, P_{coarse} is the initial predicted position, N is the number of iteration phases, αᵢ is the weight of the i^{th} iteration phase, P is the number of error planes, xⱼ is the error expectation of the j^{th} error plane, and Pⱼ is the probability that the phase position of the i^{th} iteration phase falls into the j^{th} error plane.

According to one or more embodiments of the present disclosure, there is provided a position determining method, in which the position estimation model is pre-trained in advance by:
inputting training data into the position estimation model to obtain an initial estimated position;
performing at least one pre-training iteration phase on the initial estimated position, wherein in the pre-training iteration phase: determining an error plane prediction model according to a residual error between a real position of the training data and an input position of the pre-training iteration phase, wherein an input of the error plane prediction model is a position, and an output of the error plane prediction model is an error expectation corresponding to the input position; and determining a residual expectation of the position estimation model in the pre-training iteration phase according to the error plane prediction model and a probability distribution function of the pre-training iteration phase, wherein an input of the probability distribution function is a position, and an output of the probability distribution function is a probability that the pre-training iteration phase is located at the input position;
determining a loss function of the position estimation model according to the residual expectation of each pre-training iteration phase; and
adjusting a parameter of the position estimation model to reduce the loss function of the position estimation model.

According to one or more embodiments of the present disclosure, there is provided a position determining method, in which determining the residual expectation of the position estimation model in the pre-training iteration phase according to the error plane prediction model and the probability distribution function of the pre-training iteration phase, including:
calculating the residual expectation in the pre-training iteration phase by using the following Formula 2:

$$E ( Res ) = \int [ E ( x ) ⋆ P ( x ) ] dx .$$

In Formula 2, E(Res) is the residual expectation of the calculated pre-training iteration phase, x is a position, E(x) is the error expectation of the error plane where the position x is located, P(x) is the probability that the calculated pre-training iteration phase is located at the position x, and the integral interval is the whole space.

According to one or more embodiments of the present disclosure, there is provided a position determining method, in which determining the loss function of the position estimation model according to the residual expectation of each pre-training iteration phase, including:
calculating the loss function of the position estimation model by using the following Formula 3:

$${ℒ}_{all} = {\sum }_{i = 1}^{N} {λ}_{i} \cdot {E ( Res )}_{i} .$$

In Formula 3, Lₐₗₗ represents the loss function of the position estimation model, N represents the number of pre-training iteration phases, λᵢ represents the weight of the residual expectation of the i^{th} pre-training iteration phase, and E(Res)ᵢ represents the residual expectation of the i^{th} pre-training iteration phase.

According to one or more embodiments of the present disclosure, there is provided a position determining method, in which the weight of a preceding iteration phase is greater than that of a subsequent iteration phase.

According to one or more embodiments of the present disclosure, there is provided a position determining apparatus, including:
a control unit, configured to determine whether a target object is located in a blind area of a camera at n historical moments of a historical time queue and a target moment; wherein the historical time queue is configured to store historical position information of the target object at latest n historical moments prior to the target moment, where n is a preset positive integer not less than 2;
the control unit is further configured to determine position information of the target object at the target moment acquired by the camera as the position information of the target object at the target moment in response to the target object being located outside the blind area of the camera at both of the n historical moments and the target moment.

According to one or more embodiments of the present disclosure, there is provided an electronic device including at least one memory and at least one processor;
the at least one memory is configured to store program codes, and the at least one processor is configured to call the program codes stored in the at least one memory to execute any method described above.

According to one or more embodiments of the present disclosure, there is provided a computer-readable storage medium for storing program codes which, when executed by a processor, cause the processor to perform any method described above.

The above description only refers to exemplary embodiments of the present disclosure and the explanation of the applied technical principles. It should be understood by those skilled in the art that the disclosure scope involved in the present disclosure is not limited to the technical solution formed by the specific combination of the above technical features, but also covers other technical solutions formed by any combination of the above technical features or their equivalent features without departing from the above disclosure concept. For example, the above features may be replaced with (but not limited to) technical features having similar functions disclosed in the present disclosure.

Additionally, although various operations are depicted in a particular order, this should not be understood as requiring that these operations be performed in the particular order as shown or in a sequential order. Under certain circumstances, multitasking and parallel processing may be beneficial. Likewise, although several specific implementation details are contained in the above discussion, these should not be construed as limiting the scope of the present disclosure. Some features described in the context of separate embodiments can also be combined in a single embodiment. On the contrary, various features described in the context of a single embodiment can also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. On the contrary, the specific features and actions described above are only exemplary forms of implementing the claims.

1. A position determining method, comprising:
determining whether a target object is located in a blind area of a camera at n historical moments of a historical time queue and a target moment; wherein the historical time queue is configured to store historical position information of the target object at latest n historical moments prior to the target moment, where n is a preset positive integer not less than 2; and
in response to the target object being located outside the blind area of the camera at both of the n historical moments and the target moment, determining position information of the target object acquired by the camera at the target moment as the position information of the target object at the target moment.

2. The method according to claim 1, further comprising:
acquiring posture change information of the target object at the target moment;
in response to the target object being located in the blind area of the camera at least at one of the n historical moments and the target moment, determining the position information of the target object at the target moment according to the historical time queue and the posture change information.

3. The method according to claim 2, wherein after determining that the target object is located in the blind area of the camera at least at one of the n historical moments and the target moment, and prior to determining the position information of the target object at the target moment according to the historical time queue and the posture change information, the method further comprises:
in response to the target object entering the blind area of the camera for a first time and a number of the historical position information not reaching n, ending the method.

4. The method according to claim 2, wherein determining the position information of the target object at the target moment according to the historical time queue and the posture change information comprises:
determining a relative position of the target object at the target moment relative to a previous historical moment according to the historical time queue and the posture change information, and determining the relative position as the position information of the target object at the target moment; or,
determining the relative position of the target object at the target moment relative to the previous historical moment according to the historical time queue and the posture change information, and determining the position information of the target object at the target moment according to the relative position and historical position information of the target object at the previous historical moment.

5. The method according to claim 2, wherein
in response to determining that the target object is located in the blind area of the camera at least at one of the n historical moments and the target moment, determining the position information of the target object at the target moment according to the historical time queue and the posture change information by using a position estimation model; and
in response to determining that the target object is located outside the blind area of the camera at both of the n historical moments and the target moment, maintaining or setting the position estimation model in a non-working state.

6. The method according to claim 2, wherein determining the position information of the target object at the target moment according to the historical time queue and the posture change information comprises:
inputting n pieces of historical position information in the historical time queue and the posture change information into a position estimation model to obtain an initial predicted position;
performing at least one iteration on the initial predicted position;
determining a probability that a phase position predicted in each iteration phase by the position estimation model falls into each error plane, wherein a distribution of each error plane has a corresponding error expectation; and
correcting the initial predicted position according to the probability that the phase position predicted in each iteration phase falls into each error plane and the error expectation corresponding to the error plane, to obtain a corrected predicted position; and
determining the corrected predicted position as the position information of the target object at the target moment.

7. The method according to claim 6, wherein correcting the initial predicted position according to the probability that the phase position predicted in each iteration phase falls into each error plane and the error expectation corresponding to the error plane, comprising: correcting the initial predicted position by using the following Formula 1:
$${P}_{true} = {P}_{coarse} + {\sum }_{i = 1}^{N} {λ}_{i} ( {\sum }_{j = 1}^{P} ( {x}_{j} \cdot {p}_{j} ) ) ,$$
in the Formula 1, Pₜᵣᵤₑ is the corrected prediction position, P_{coarse} is the initial predicted position, N is a number of the iteration phase, λᵢ is a weight of an i^{th} iteration phase, P is a number of the error plane, xⱼ is the error expectation of a j^{th} error plane, and Pⱼ is a probability that the phase position of the i^{th} iteration phase falls into the j^{th} error plane.

8. The method according to claim 6, wherein the position estimation model is pre-trained by:
inputting training data into the position estimation model to obtain an initial estimated position;
performing at least one pre-training iteration phase on the initial estimated position, wherein in the pre-training iteration phase: determining an error plane prediction model according to a residual error between a real position of the training data and an input position of the pre-training iteration phase, wherein an input of the error plane prediction model is a position, and an output of the error plane prediction model is an error expectation corresponding to the input position; and determining a residual expectation of the position estimation model in the pre-training iteration phase according to the error plane prediction model and a probability distribution function of the pre-training iteration phase, wherein an input of the probability distribution function is a position, and an output of the probability distribution function is a probability that the pre-training iteration phase is located at the input position;
determining a loss function of the position estimation model according to the residual expectation of each pre-training iteration phase; and
adjusting a parameter of the position estimation model to reduce the loss function of the position estimation model.

9. The method according to claim 8, wherein determining the residual expectation of the position estimation model in the pre-training iteration phase according to the error plane prediction model and the probability distribution function of the pre-training iteration phase comprises:
calculating the residual expectation in the pre-training iteration phase by using the following Formula 2:
$$E ( Res ) = \int [ E ( x ) ⋆ P ( x ) ] dx ,$$
in the Formula 2, E(Res) is the residual expectation of the pre-training iteration phase under calculation, x is the position, E(x) is the error expectation of the error plane where the position x is located, P(x) is a probability that the pre-training iteration phase under calculation is located at the position x, and an integral interval is a whole space.

10. The method according to claim 8, wherein determining the loss function of the position estimation model according to the residual expectation of each pre-training iteration phase comprises:
calculating the loss function of the position estimation model by using the following Formula 3:
$${ℒ}_{all} = {\sum }_{i = 1}^{N} {λ}_{i} \cdot {E ( Res )}_{i} ,$$
in the Formula 3, Lₐₗₗ represents the loss function of the position estimation model, N represents a number of the pre-training iteration phase, λᵢ represents a weight of the residual expectation of an i^{th} pre-training iteration phase, and E(Res)ᵢ represents the residual expectation of the i^{th} pre-training iteration phase.

11. The method according to claim 7, wherein the weight of a preceding iteration phase is greater than the weight of a subsequent iteration phase.

12. An electronic device, comprising at least one memory and at least one processor, wherein
the at least one memory is configured to store program codes, and
the at least one processor is configured to call the program codes stored in the at least one memory to execute a position determining method, comprising:
determining whether a target object is located in a blind area of a camera at n historical moments of a historical time queue and a target moment; wherein the historical time queue is configured to store historical position information of the target object at latest n historical moments prior to the target moment, where n is a preset positive integer not less than 2; and
in response to the target object being located outside the blind area of the camera at both of the n historical moments and the target moment, determining position information of the target object acquired by the camera at the target moment as the position information of the target object at the target moment.

13. The electronic device according to claim 12, wherein the position determining method further comprises:
acquiring posture change information of the target object at the target moment;
in response to the target object being located in the blind area of the camera at least at one of the n historical moments and the target moment, determining the position information of the target object at the target moment according to the historical time queue and the posture change information.

14. The electronic device according to claim 13, wherein in the position determining method,
after determining that the target object is located in the blind area of the camera at least at one of the n historical moments and the target moment, and prior to determining the position information of the target object at the target moment according to the historical time queue and the posture change information, further comprising:
in response to the target object entering the blind area of the camera for a first time and a number of the historical position information not reaching n, ending the method.

15. The electronic device according to claim 13, wherein in the position determining method,
determining the position information of the target object at the target moment according to the historical time queue and the posture change information comprises:
determining a relative position of the target object at the target moment relative to a previous historical moment according to the historical time queue and the posture change information, and determining the relative position as the position information of the target object at the target moment; or,
determining the relative position of the target object at the target moment relative to the previous historical moment according to the historical time queue and the posture change information, and determining the position information of the target object at the target moment according to the relative position and historical position information of the target object at the previous historical moment.

16. The electronic device according to claim 13, wherein in the position determining method,
in response to determining that the target object is located in the blind area of the camera at least at one of the n historical moments and the target moment, determining the position information of the target object at the target moment according to the historical time queue and the posture change information by using a position estimation model; and
in response to determining that the target object is located outside the blind area of the camera at both of the n historical moments and the target moment, maintaining or setting the position estimation model in a non-working state.

17. The electronic device according to claim 13, wherein in the position determining method,
determining the position information of the target object at the target moment according to the historical time queue and the posture change information comprises:
inputting n pieces of historical position information in the historical time queue and the posture change information into a position estimation model to obtain an initial predicted position;
performing at least one iteration on the initial predicted position;
determining a probability that a phase position predicted in each iteration phase by the position estimation model falls into each error plane, wherein a distribution of each error plane has a corresponding error expectation; and
correcting the initial predicted position according to the probability that the phase position predicted in each iteration phase falls into each error plane and the error expectation corresponding to the error plane, to obtain a corrected predicted position; and
determining the corrected predicted position as the position information of the target object at the target moment.

18. The electronic device according to claim 17, wherein in the position determining method,
correcting the initial predicted position according to the probability that the phase position predicted in each iteration phase falls into each error plane and the error expectation corresponding to the error plane, comprising: correcting the initial predicted position by using the following Formula 1:
$${P}_{true} = {P}_{coarse} + {\sum }_{i = 1}^{N} {λ}_{i} ( {\sum }_{j = 1}^{P} ( {x}_{j} \cdot {p}_{j} ) ) ,$$
in the Formula 1, Pₜᵣᵤₑ is the corrected prediction position, P_{coarse} is the initial predicted position, N is a number of the iteration phase, λᵢ is a weight of an i^{th} iteration phase, P is a number of the error plane, xⱼ is the error expectation of a j^{th} error plane, and Pⱼ is a probability that the phase position of the i^{th} iteration phase falls into the j^{th} error plane.

19. The electronic device according to claim 18, wherein in the position determining method, the weight of a preceding iteration phase is greater than the weight of a subsequent iteration phase.

20. A computer-readable storage medium for storing program codes, wherein the program codes, when executed by a processor, cause the processor to perform a position determining method, comprising:
determining whether a target object is located in a blind area of a camera at n historical moments of a historical time queue and a target moment; wherein the historical time queue is configured to store historical position information of the target object at latest n historical moments prior to the target moment, where n is a preset positive integer not less than 2; and
in response to the target object being located outside the blind area of the camera at both of the n historical moments and the target moment, determining position information of the target object acquired by the camera at the target moment as the position information of the target object at the target moment.
